(19) United States
(12) Patent Application Publication
(10) Pub. No.: US 2026/0036738 A1
(43) Pub. Date: Feb. 5, 2026

(54) HOLLOW-CORE OPTICAL FIBERS, FIBER OPTIC CABLE ASSEMBLIES WITH SAME, AND METHODS OF MAKING SAME

(71) Applicant: CORNING RESEARCH & DEVELOPMENT CORPORATION, Corning, NY (US)

(72) Inventors: Robert Bruce Elkins, II, Hickory, NC (US); Tory Allen Klavuhn, Granite Falls, NC (US); Darrin Max Miller, Hickory, NC (US)

(21) Appl. No.: 19/243,233

(22) Filed: Jun. 19, 2025

Related U.S. Application Data
(60) Provisional application No. 63/677,431, filed on Jul. 31, 2024.

(51) Int. Cl. G02B 6/02; G02B 6/38; G02B 6/44

(52) U.S. Cl. CPC G02B 6/02304; G02B 6/3839; G02B 6/3869; G02B 6/3885; G02B 6/443

(57) ABSTRACT

A hollow-core optical fiber for a fiber optic network is disclosed. The hollow-core optical fiber includes opposing end portions. A main portion extends between end portions. A tapered region is between an end portion and the main portion. One end portion has a reduced outer dimension. A cladding defines an inner surface of the main portion. The inner surface defines a hollow core. The cladding includes a doped layer. At least one end portion and tapered region has a solid core. The main portion has an outer diameter greater than 126 μm and one end portion has an outer diameter of 126 μm or less. A fiber optic cable assembly includes a hollow-core optical fiber, and optionally one or more single mode fibers (SMF) and/or multimode fibers (MMF), terminated by a fiber optic connector. A method of making such a hollow-core optical fiber and cable assembly is also disclosed.

### PRIORITY APPLICATION

This application claims the benefit of priority of U.S. Provisional Application No. 63/677,431, filed on Jul. 31, 2024, the content of which is relied upon and incorporated herein by reference in its entirety.

### TECHNICAL FIELD

This disclosure relates generally to optical connectivity, and more particularly to hollow-core optical fibers for fiber optic network connectivity, assemblies utilizing hollow-core optical fibers, and methods for making hollow-core optical fibers.

### BACKGROUND

Optical fibers are useful in a wide variety of applications, including the telecommunications industry for voice, video, and data transmissions. The benefits of optical fiber are well known and include higher signal-to-noise ratios and increased bandwidth compared to conventional copper-based transmission technologies.

Conventionally, “optical fibers” in the telecommunications industry refers to optical fibers having a solid core as a medium for propagating light. A cladding surrounds the core and an outer coating oftentimes surrounds the cladding. Each of the core and cladding is solid. The core is typically glass as is the cladding with a primary difference between the core and the cladding being the index of refraction of the glass. Most often, the cladding has a lower index of refraction than the index of refraction of the core, though the reverse relationship is also possible. The interface between the core and cladding, when combined with the dimensions of the core itself, facilitates total internal reflection of light introduced into the core. Light introduced at one end of the optical fiber therefore propagates over long distances with little attenuation and with little dispersion at high bandwidths.

Current telecommunications systems require connection between the optical fibers and equipment or connection to other fiber optic cables. To provide these connections, fiber optic connectors are often provided on the ends of fiber optic cables to non-permanently connect and disconnect optical elements in a fiber optic network. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

In contrast to optical fiber in which a solid core is the conduit through which light propagates, there are hollow-core optical fibers (HCF) in which the core of the fiber is gas with a surrounding shell, typically of glass. While filled with gas instead of being a solid, the core is the medium through which light propagates. There are advantages to HCFs including faster light transmission, low latency, and capability of use with ultra short pulse lasers. Further, HCFs can transmit high power over long distance without non-linear distortion sometimes present in optical fibers constructed with a solid core.

There are, however, disadvantages with HCF. For one, HCF is more vulnerable to contaminants (e.g., dust, dirt, oils, moisture, particulates, etc.) that may get lodged or trapped inside the hollow core of the optical fiber. The contaminants often impede propagation and degrade performance, and may contribute to interference, noise, or loss. Another limitation to HCF is size. Typically, HCF outside diameter is in a range from 180 μm to 260 μm. By comparison, commercial solid glass fibers are typically 125 μm in diameter. The relatively larger size of HCF impedes its use in current fiber optic systems simply because current systems are built around a 125 μm outer diameter fiber. More specifically, the relative large size of HCF means that HCF is not compatible with standard, commercial optical fiber connectors.

In view of the above, there is a need in the telecommunications industry for hollow-core optical fibers that eliminate the ingress of contaminants into the hollow core of the fiber and are usable with standard connectors and connectorization technology.

### SUMMARY

In one aspect of the disclosure, a hollow-core optical fiber for a fiber optic network is disclosed. Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

In one embodiment, a hollow-core optical fiber for a fiber optic network may include a first end portion opposing a second end portion. A main portion is between the first end portion and the second end portion. A tapered region is between at least one of the first end portion and the second end portion and the main portion. One or both of the first end portion and the second end portion has a reduced outer dimension relative to a corresponding outer dimension of the main portion. In one embodiment, the main portion includes a cladding defining an inner surface. The inner surface defines a hollow core. In one embodiment, the cladding includes a doped layer adjacent the inner surface. In one embodiment, the doped layer includes germanium, and the cladding includes an outer portion in which germanium is not present. In one embodiment, the hollow-core optical fiber further includes a plurality of nested capillaries captured by inner surface. In one embodiment, at least one of the first end portion, the second end portion, and tapered region has a solid core.

In one embodiment, the main portion has an outer diameter greater than 126 μm and one of the first end portion and the second end portion has an outer diameter of 126 μm or less. In one embodiment, one of the first end portion and the second end portion is at least 1 mm in length.

In a second aspect of the disclosure, there is a fiber optic cable assembly including one or more of the hollow-core optical fibers according to the first aspect described above and a fiber optic connector connected to one or more optical fibers. At least one of the one or more optical fibers is the one or more hollow-core optical fiber.

In one embodiment, the fiber optic cable assembly may include one or more single mode fibers (SMF) and/or multimode fibers (MMF). In this embodiment, the one or more optical fibers connected to the fiber optic connector may be a SMF and/or a MMF. In one embodiment, the fiber optic connector may include a ferrule and the first end portion or the second end portion of the hollow-core optical fiber having the reduced dimension may be received in the ferrule. Moreover, the tapered region of the hollow-core optical fiber may be inside the ferrule or outside the ferrule. In one embodiment, the fiber optic connector may include a housing and the tapered region of the hollow-core optical fiber may be inside the housing. In another embodiment, the tapered region of the hollow-core optical fiber may be outside the housing. In one embodiment, the ferrule may include one or more ferrule microholes and one or more of the hollow-core optical fibers according to the first aspect described above. The at least one of the first end portion and second end portion are received into the one or more ferrule micro holes.

In a third aspect of the disclosure, a method of manufacturing a hollow-core optical fiber includes heating an end portion of a hollow-core optical fiber having a main portion, drawing the heated end, and forming a tapered region in the heated end. The tapered region has a reduced outer dimension relative to a corresponding outer dimension of the main portion.

In one embodiment, before heating, the method may further include cutting the hollow-core optical fiber to form the end portion. In one embodiment, drawing the heated end includes drawing the heated end through one or more dies to form the taper. In one embodiment, drawing and forming occur simultaneously.

In a fourth aspect of the disclosure, a method of assembling a fiber optic cable assembly includes providing one or more hollow-core optical fibers each made according to the third aspect described above and connecting the one or more hollow-core optical fibers to a fiber optic connector.

In one embodiment, the method may further include providing one or more single mode fibers (SMF) and/or multimode fibers (MMF) and connecting may include connecting the one or more single mode fibers (SMF) and/or multimode fibers (MMF) to the fiber optic connector. In one embodiment, the fiber optic connector may include a ferrule and connecting the plurality of optical fibers to the fiber optic connector may include positioning the tapered portion of the one or more hollow-core optical fibers inside the ferrule. In one embodiment, the fiber optic connector may include a housing and connecting the plurality of optical fibers to the fiber optic connector may include positioning the tapered region inside the housing.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of one embodiment of a hollow-core optical fiber.

FIG. 2 is a cross-sectional view of the hollow-core optical fiber of FIG. 1 taken along section line 2-2.

FIG. 3 is a cross-sectional view of the hollow-core optical fiber of FIG. 1 taken along section line 3-3.

FIG. 4 is a perspective view of a fiber optic cable assembly having a fiber optic cable terminated by an MMC fiber optic connector according to one embodiment.

FIG. 5 is a perspective view of a very small form factor ferrule in the form of a TMT ferrule and connected fiber optic cables according to one embodiment.

FIG. 5A is a cross-sectional view taken along section line 5A-5A of FIG. 5.

### DETAILED DESCRIPTION

Various embodiments will be further clarified by examples in the description below. In general, embodiments of the disclosure generally relate to hollow-core optical fibers that are usable in fiber optic networks in conjunction with fibers having solid cores, including those with a glass core and cladding. For example, fiber optic networks may include fiber optic cables in which a plurality of optical fibers are carried. Any single one of the optical fibers may be a single mode fiber (SMF) or a multimode fiber (MMF). SMF is characterized by a core diameter of 8 μm and a cladding (i.e., outer) diameter of 126 μm and less. MMF may be characterized by a 62.5 μm core diameter and a cladding diameter 126 μm and less. Other solid core diameters are possible, for example, the core diameter may be 50 μm. While the core diameter may vary for SMF and MMF, for most commercial SMF and MMF, the cladding diameter (i.e., outer diameter) is 125 μm.

To facilitate coupling of SMF and MMF to fiber optic networks, LC, SC, and MPO connectors are designed to receive a plurality of SMF and/or MMF having a cladding diameter of 125 μm. Stated in other words, these connectors are not designed be utilized with optical fibers having outer diameters greater than 125 μm or so. Embodiments of the disclosure address the lack of compatibility between commercial connectors with hollow-core optical fibers. To that end, embodiments of the hollow-core optical fiber disclosed herein are receivable in connectors either at the factory or during field-installed connectorization. An exemplary fiber optic cable assembly according to one aspect of the disclosure is described below.

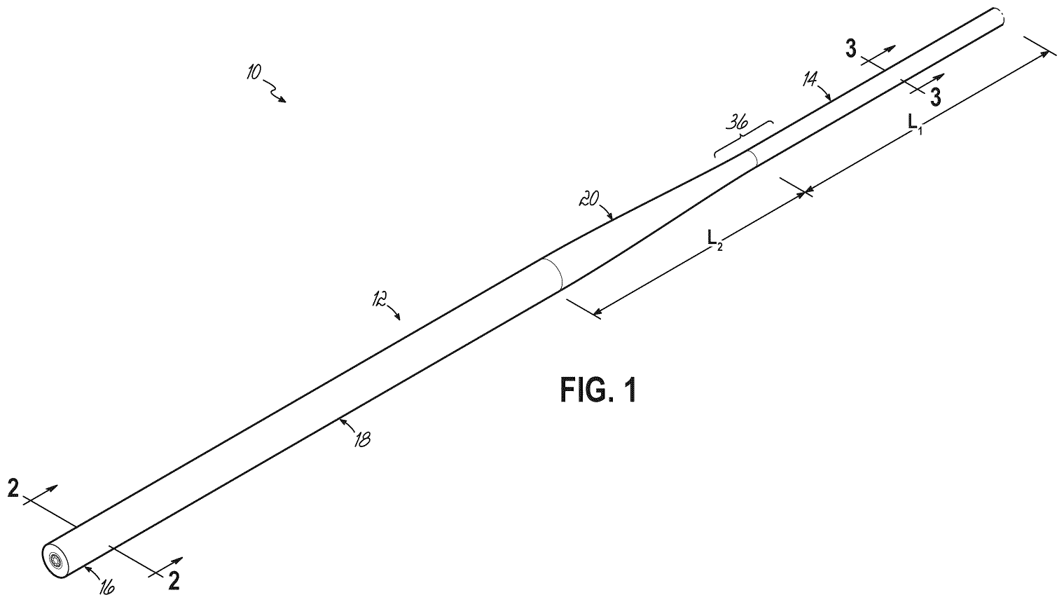

With reference to FIG. 1, in an exemplary embodiment, a hollow-core optical fiber (HCF) 10 is a generally tubular body 12 having opposing ends portions 14, 16 along a longitudinal axis. The HCF 10 may be made of glass and is configured to carry light over large distances. The HCF 10 has the same general purpose as a SMF and a MMF in transmitting data over large distances. One or both the end portions 14, 16 has a reduced dimension (e.g., cross-sectional diameter) relative to a main portion 18 of the HCF 10. In the exemplary embodiment shown, a tapered region 20 between the end portion 14 and the main portion 18 transitions the dimension from that of the main portion 18 to the dimension of the end portion 14. Exemplary embodiments of the disclosure do not include a splice between the main portion 18 and the end portion 14. That is, the HCF 10 is monolithic from the end portion 14 to the opposing end portion 16 and is not constructed by splicing two or more fibers together.

In FIG. 1, only the end portion 14 has a reduced dimension relative to the main portion 18 of the HCF 10. The end portion 16 and main portion 18 have a uniform dimension. Although not shown, the end portion 16 may have a reduced dimension relative to the main portion 18. The reduced dimension of the end portion 16 may be different from, or the same as, the reduced dimension of the end portion 14. Embodiments of the disclosure therefore contemplate the HCF 10 having end portions 14 and 16 each having a reduced dimension relative to the main portion 18. Further, while a length L₁ of the end portion 14 may vary, in exemplary embodiments, the length L₁ is at least 1 mm. By way of further example, the length L₁ may be in the range of 1 mm to 7 mm with 9 mm to 10 mm contemplated. The length L₁ may only be a small portion of an overall length of the HCF 10. In particular, the main portion 18 may measure kilometers long relative to the few millimeters of the end portion 14 and/or 16.

In the exemplary embodiment shown, the tapered region 20 transitions from the dimension of the main portion 18 to the dimension of the end portion 14. The transition from one dimension to the other dimension may be linear or nonlinear and may depend upon the process by which the tapered region 20 is formed. By way of example, a ratio of dimension reduction per unit length in the tapered region may be about 0.3. With a continuous reduction in dimension, the tapered region 20 lacks a single outer dimension. While not being of any particular length, the tapered region 20 may have a length L₂ in the range of greater than 0 mm to 5 mm though lengths greater than 5 mm are possible. Further, while break lines are shown in FIG. 1 for the tapered region 20, these are to visually aid location of a start and end to the tapered region 20 in FIG. 1.

With reference now to FIG. 2, in the exemplary embodiment, the main portion 18 of the HCF 10 includes a cladding 22 including an inner surface 24. The inner surface 24 defines a hollow core filled with a gas or may be evacuated. In the exemplary embodiment, a plurality of nested capillaries 26 are shown contained in the cladding 22 and within the hollow core. In the exemplary embodiment, the cladding 22 includes a layer of doped glass 30 adjacent the inner surface 24. The doped layer 30 is sufficient to create a difference in the refractive index of the doped layer 30 relative to the refractive index of the cladding 22. For example, the doped layer 30 may include germanium. In that embodiment, germanium is not present in an outer portion 32 of the cladding 22. The outer diameter D₁ of the main portion 18 of the HCF 10 may be at least 200 μm (e.g., 260 μm) with the inner surface 24 defining an inside diameter D₂ of 20 μm to 40 μm.

Embodiments of the invention are not limited to use of germanium. By way of additional example, other dopants may include one or more of fluorine, aluminum, and boron, to name only a few. In an alternative embodiment, while not shown, the main portion 18 may have a doped layer adjacent the outer surface by which a refractive index difference is achieved. For example, an outer ring layer may be doped to decrease the refractive index of the outer ring layer relative to an undoped inner ring layer. Although not shown, a concentration profile of dopant within the doped layer 30 may be a gradient profile in which the highest concentration of the dopant is present at or near the inner surface 52 and decrease in concentration in a radial direction outwardly. As another example, a concentration profile may be a trench profile.

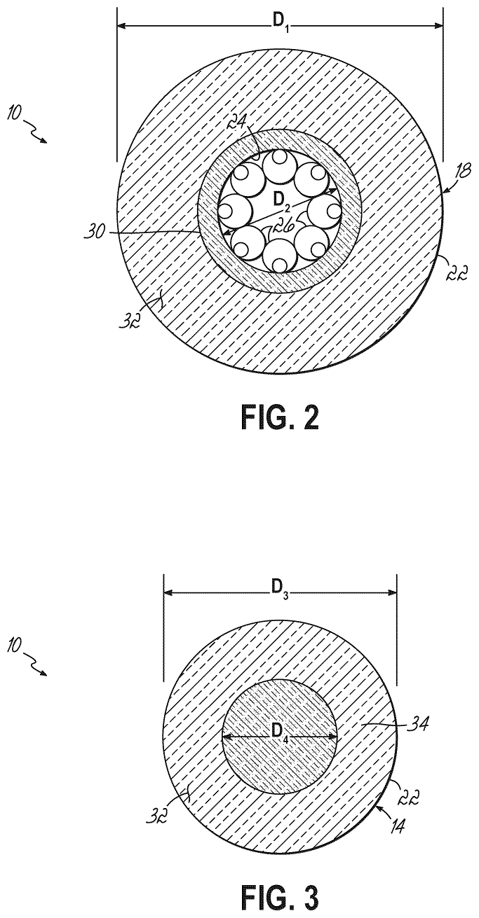

Referring to FIG. 3, in the exemplary embodiment, the end portion 14 of the HCF 10 includes the cladding 22, though the cladding 22 surrounds a solid core 34. In other words, the cladding 22 no longer defines the inner surface 24 in the end portion 14 so that the HCF 10 may be hollow along nearly its entire length but be closed off at at least the end portion 14. Advantageously, closing off the end portion 14 eliminates the possibility of contaminates from entering the hollow core present in the main portion 18. The cladding 22 is the same material present in the main portion 18 shown in FIG. 2. For example, the solid core 34 contains a doping agent, such as germanium in the doped layer 30 of the main portion 18. In the exemplary embodiment, the outer portion 32 adjacent the solid core 34 lacks the doping agent. Embodiments of the invention are not limited to the arrangement of the doped layer 30 in the main portion 18 and the solid core 34. For example, rather than a doped inner layer, an outer layer may be doped to achieve a difference in index of refraction. Referring to FIG. 3, the outer diameter D₃ may extend over the entire length L₁ of the end portion 14. That is, the diameter D₃ of the end portion 14 may be uniform. The diameter D₃ of the end portion 14 may be 125 μm with the diameter D₄ being from 5 μm to 63 μm. By way of further example, the diameter D₄ may be the same as a standard SMF core of 8 μm or the same as a standard MMF core of 50 μm or 62.5 μm.

In the exemplary embodiment shown in FIGS. 1, 2, and 3, a transition from the hollow core present in the main portion 18 to the solid core 34 present in the end portion 14 occurs in the tapered region 20. Specifically, as the outer dimension D₁ of the main portion 18 is reduced to the outer dimension D₃ of the end portion 14, the inner surface 24 is gradually reduced, thus reducing the cross-sectional area of the hollow core until the inner surface 24 in a given cross section disappears and the solid core 34 is formed. The plurality of nested capillaries 26 may also extend the length of the tapered region 20 but collapse and form a portion of the solid core 34. As such, the solid core 34 may be present in a region 36 as indicated in FIG. 1 and extend the length L₁ of the end portion 14. The tapered region 20 may not be hollow over its entire length.

According to one aspect, an exemplary hollow-core optical fiber 10 may be made by doping a hollow-core optical fiber with germanium along its entire length thus forming the doped layer 30 (FIG. 2). The end portion 14, 16 and the tapered region 20 may be formed by heating a corresponding portion of the doped hollow-core optical fiber and then applying a tensile load to draw the end portion 14, 16 and form the tapered region 20 in the drawing process. As examples, heating may be achieved by application of a laser and an electric arc, to name two. Once sufficiently heated, the hollow-core optical fiber may be drawn through a die, an aperture, or similar to reduce the dimensions of an end portion in accordance with those described above. The reduction in the outer dimension may be controlled by tension and heat. The process of forming the end portion 14, 16 may be completed in the field and so may include initially cutting a doped hollow-core optical fiber to a specific length prior to heating and drawing. The end portion is then formed along a length of one end proximate the cut location.

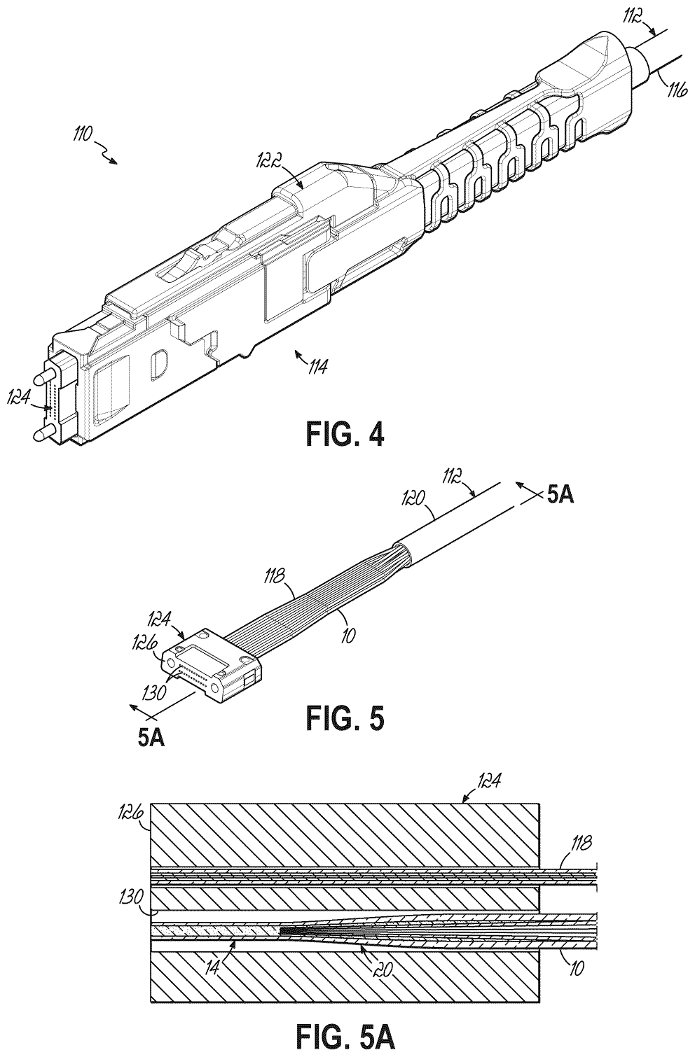

With reference to FIG. 4, the HCF 10 may be assembled alone or with one or more SMF and/or MMF in an exemplary fiber optic cable assembly 110. Fibler optic connectors are generally structures that enable mating of an optical fiber to another optical component. These include, but are not limited to, connectors including v-grooves and ferrule microholes that are configured to receive optical fibers. As an example and as illustrated in FIGS. 4 and 5, an exemplary fiber optic cable assembly 110 includes a fiber optic cable 112 and at least one fiber optic connector 114 terminating the fiber optic cable 112 at a first end 116 of the fiber optic cable 112 (one shown). A second opposite end (not shown) of the fiber optic cable 112 may also include a fiber optic connector, e.g., similar to fiber optic connector 114, terminating the fiber optic cable 112 at that end. The fiber optic cable 112 carries a plurality of optical fibers 118 within an outer jacket or sheath 120 of the fiber optic cable 112. In one embodiment, the fiber optic cable 112 may carry twelve optical fibers 118. One or more of the twelve optical fibers 118 is the HCF 10 (FIG. 5) shown in FIGS. 1-3 and described above. The remaining optical fibers 118 may include one or more SMF and/or MMF. In an alternative embodiment, the fiber optic cable 112 may carry a plurality of cable subunits (e.g., six or eight cable subunits; not shown), where each cable subunit may carry a plurality of optical fibers, such as twelve optical fibers 118 with one or more of the twelve being the HCF 10. The remaining optical fibers 118 may include one or more SMF and/or MMF. It should be appreciated, however, that the fiber optic cable 112 and/or the cable subunits of the fiber optic cable 112 may carry more of less optical fibers depending on the particular application.

Through the process of connectorization, the optical fibers 118 carried by the fiber optic cable 112 may be terminated by one or more fiber optic connectors 114 (one shown). The fiber optic connector 114 of the fiber optic cable assembly 110 generally includes a housing assembly 122 and a ferrule 124 (FIGS. 5 and 5A) substantially positioned in the housing assembly 122. The tapered region 20 of the HCF 10 may be inside the housing assembly 122, for example inside of the ferrule 124 (FIG. 5A) or outside of the ferrule 124 (not shown). Alternatively, the tapered region 20 of the HCF 10 may reside within the cable 112 though outside of the housing assembly 122. The ferrule 124 includes a front end surface 126 configured to face towards and abut another connector or optical receptacle. The ferrule 124 is configured to position the terminal end of the hollow-core optical fiber 10 proximate to the front end surface 126 so that light energy can be transmitted to and/or from the hollow-core optical fiber 10. As shown in FIG. 5, the ferrule 124 includes a plurality of bores 130 extending through the ferrule body to accommodate the hollow-core optical fibers 10 and one or more SMF and/or MMF 118. Each of the bores 130 is sized to receive one of the hollow-core optical fibers 10 or one of the SMF and/or MMF 118. It will be appreciated that alternative versions of the ferrule 124 may include multiple rows of bores 130 and different alignments. As an example, in FIGS. 4 and 5, the fiber optic connector 114 shown is an MMC fiber optic connector sold by US Conec Ltd. The MMC fiber optic connector is considered to be part of a class of fiber optic connectors referred to as very small form factor (VSFF) connectors, which have small footprint ferrules 124 and connector housing assemblies compared to standard fiber optic connectors in the telecommunications industry. By way of example, the MMC fiber optic connector utilizes a very small form factor MT-style ferrule, referred to as a TMT ferrule. While embodiments are described in reference to the MMC fiber optic connector and the TMT ferrule, embodiments of the disclosure are applicable to other fiber optic connectors (and more specifically the ferrules used therein), including both conventional multifiber fiber optic connectors and VSFF fiber optic connectors other than the MMC fiber optic connector.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A hollow-core optical fiber for a fiber optic network, comprising:
a first end portion opposing a second end portion;
a main portion between the first end portion and the second end portion; and
a tapered region between at least one of the first end portion and the second end portion and the main portion,
wherein one or both of the first end portion and the second end portion has a reduced outer dimension relative to a corresponding outer dimension of the main portion.

2. The hollow-core optical fiber of claim 1, wherein the main portion includes a cladding defining an inner surface, and wherein the inner surface defines a hollow core;
wherein the cladding includes a doped layer adjacent the inner surface; and
a plurality of nested capillaries captured by the inner surface.

3. The hollow-core optical fiber of claim 2, wherein the doped layer includes germanium, and wherein the cladding includes an outer portion in which germanium is not present.

4. The hollow-core optical fiber of claim 1, wherein at least one of the first end portion, the second end portion, and the tapered region has a solid core.

5. The hollow-core optical fiber of claim 1, wherein the main portion has an outer diameter of 126 μm or greater and one of the first end portion and the second end portion has an outer diameter of 126 μm or less.

6. A fiber optic cable assembly, comprising:
a hollow-core optical fiber for a fiber optic network, comprising:
a first end portion opposing a second end portion;
a main portion between the first end portion and the second end portion; and
a tapered region between at least one of the first end portion and the second end portion and the main portion,
wherein one or both of the first end portion and the second end portion has a reduced outer dimension relative to a corresponding outer dimension of the main portion;
a fiber optic connector connected to one or more optical fibers,
wherein at least one of the one or more optical fibers is the one or more of the hollow-core optical fibers.

7. The fiber optic cable assembly of claim 6, further comprising one or more SMF and/or MMF, and wherein the one or more optical fibers connected to the fiber optic connector includes a SMF and/or a MMF.

8. The fiber optic cable assembly of claim 6, wherein the fiber optic connector includes a ferrule and the first end portion or the second end portion of the hollow-core optical fiber having the reduced dimension is received in the ferrule.

9. The fiber optic cable assembly of claim 8, wherein the tapered region of the hollow-core optical fiber is inside the ferrule.

10. The fiber optic cable assembly of claim 8, wherein the tapered region of the hollow-core optical fiber is outside the ferrule.

11. The fiber optic cable assembly of claim 6, wherein the fiber optic connector includes a housing and the tapered region of the hollow-core optical fiber is inside the housing.

12. The fiber optic cable assembly of claim 6, wherein the fiber optic connector includes a housing and the tapered region of the hollow-core optical fiber is outside the housing.

13. A method of manufacturing a hollow-core optical fiber comprising:
heating an end portion of a hollow-core optical fiber having a main portion;
drawing the heated end; and
forming a tapered region in the heated end,
wherein the tapered region has a reduced outer dimension relative to a corresponding outer dimension of the main portion.

14. The method of claim 13, wherein before heating, the method further comprises cutting the hollow-core optical fiber to form the end portion.

15. The method of claim 13, wherein drawing the heated end includes drawing the heated end through one or more dies.

16. The method of claim 13, wherein drawing and forming occur simultaneously.

17. A method of assembling a fiber optic cable assembly, comprising:
providing one or more hollow-core optical fibers each made according to claim 13;
connecting the one or more hollow-core optical fibers to a fiber optic connector.

18. The method of claim 17, further comprising:
providing one or more single mode fibers (SMF) and/or multimode fibers (MMF),
wherein connecting includes connecting the one or more single mode fibers (SMF) and/or multimode fibers (MMF) to the fiber optic connector.

19. The method of claim 17, wherein the fiber optic connector includes a ferrule, and wherein connecting the one or more hollow-core optical fibers to the fiber optic connector includes positioning the tapered portion of the one or more hollow-core optical fibers inside the ferrule.

20. The method of claim 17, wherein the fiber optic connector includes a housing, and wherein connecting the one or more hollow-core optical fibers to the fiber optic connector includes positioning the tapered region inside the housing.
